(19) United States
(12) Patent Application Publication
(10) Pub. No.: US 2014/0282984 A1
(43) Pub. Date: Sep. 18, 2014

(54) SERVICE RELATIONSHIP AND COMMUNICATION MANAGEMENT

(71) Applicant: MICROSOFT CORPORATION, Redmond, WA (US)

(72) Inventors: Benny Schlesinger, Ramat Hasharon (IL); Hen Fitoussi, Tel-Aviv (IL)

(73) Assignee: Microsoft Corporation, Redmond, WA (US)

(21) Appl. No.: 13/804,046

(22) Filed: Mar. 14, 2013

(51) Int. Cl. H04L 29/06

(52) U.S. Cl. CPC H04L 63/0869
USPC 726/9

(57) ABSTRACT

Communication between a user and various services (e.g., websites) often involves creating a user profile comprising contact information (e.g., a personal email address) that the service uses to contact the user. However, managing communication may be burdensome and ineffective; the user's privacy may be diminished; and revocation of previously issued permission may be unachievable. Presented herein are techniques for providing a communication manager that establishes relationships with services on behalf of users, and that issues tokens to the services representing such relationships. In order to communicate with the user, the service presents the token to the communication manager, which conditions the authorization of the communication on verification of the current permission of user in the relationship represented by the token, optionally including the communication channel of the user requested by the service. This architecture enables more consistent, convenient, privacy-preserving, and revocable user control of communication permissions with the services.

### BACKGROUND

Within the field of computing, many scenarios involve a relationship established between a user and one or more services, such as one or more websites or internet services, and communication exchanged therebetween. In many such scenarios, the user may create an account or user profile with the service that includes a set of information about the user, including one or more communication channels through which the service may contact the user, such as an email address or phone number. Many such services enable the user to customize the communication sent to the user by the service, such as subscription mechanisms that allow the user to specify which types of messages the user wishes to receive from the service. However, some services may not provide such customizable options, or may not respect the wishes of the user regarding desired communications. As a first example, a service may continue to contact the user after the user has requested a cessation of communication. As a second example, a service may transmit the user's contact information to third parties who have no relationship with the user, such as telemarketers or bulk unsolicited email (“spam”) advertisers, who may send frequent and potentially voluminous messages to the user with no option for the user to request cessation of unwanted contact. In such scenarios, the user may reduce or eliminate unwanted contact by utilizing various technical measures, such as communication filters at a communication endpoint (e.g., implementing a spam filter or blacklist on an email device, or a blocked called on a mobile phone), and/or various technical or procedural mechanisms (e.g., registering with a “do-not-call” registry, or compelling a service provider to block a particular type of contact). Occasionally, such users may even abandon a communication channel due to unwanted contact, such as closing an email account or switching phone numbers.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While a user may utilize many options to manage communication received from various services, such management may exhibit many disadvantages. As a first example, the process of creating and managing user accounts with many services may present a significant administrative task for the user. As a second example, the information in a user account may become outdated (e.g., a user account of a website may include an outdated email address or telephone number for the user, and communication intended for the user may fail to be delivered or may inadvertently be transmitted to a third party). As a third example, the options available for restricting unwanted communication may involve significant management, and may be incompletely effective (e.g., spam advertisers may evade blacklisting by sending spam to the user from a wide variety of email accounts), and aggressive blacklisting may result in false positives that withhold legitimate messages from the user. As a fourth example, a user may be unable to revoke previously granted permission for a service to contact the user; e.g., once the user provides a personal email address to a service, it may be difficult to prohibit the continued use of the email address by the service or third parties. As a fifth example, the user may wish to interact with the service in an anonymous or pseudonymous manner, and therefore may wish to avoid disclosing personally identifying communication channels, such as a home address or personal phone number.

Presented herein are communication management techniques that may enable tighter control of communication by various services. In accordance with these techniques, communication from various services with the user may be regulated by a communication manager service that tracks the relationships established by the user with respective services, and that authorizes communication from the services with the user. For example, the user may request the communication manager service to create relationships with one or more services, and may specify the communication channels through which the user authorizes the service to contact the user. As a representation of this authorization, the communication manager service may send the service a token representing the relationship with the user and the permission to contact the user. When the service wishes to communicate with the user (e.g., through email, simple message service (SMS) message, a voice call, or a mailing address), the service may present the request to communicate and the token to the communication manager service, which may verify that the relationship between the service and the user (represented by the token) currently permits the requested communication, and may therefore permit or deny the requested communication with the user (e.g., by forwarding the message to the user, or by facilitating the initiation of a communication session between the service and a device of the user). By delegating the permission and details of permitted communication from various services to the communication manager service rather than implementing less sophisticated and endpoint-based communication filters, the user may achieve more specific control of permitted contact, including the capability of revoking contact permission at a later time. Additionally, delegating the relationship establishment process to the communication manager service may reduce the administrative burdens to the user, facilitate the maintenance of current information for authorized senders, and enable anonymous or pseudonymous accounts through a trusted intermediary. These and other advantages may be achievable by utilizing a communication manager service to mediate relationship management and communication permission with respective services on behalf of the user in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring communication between a user and a set of services respectively having a user profile for the user.

FIG. 2 is an illustration of an exemplary scenario featuring a communication manager configured to establish relationships and mediate communication between a set of services and a user in accordance with the techniques presented herein.

FIG. 3 is an illustration of an exemplary method of facilitating relationships and communication between a user and a set of services through a communication manager in accordance with the techniques presented herein.

FIG. 4 is an illustration of an exemplary method of facilitating relationships and communication between a user and a set of services through interaction with a communication manager in accordance with the techniques presented herein.

FIG. 5 is a component block diagram illustrating exemplary systems for configuring a communication manager and a client device to facilitate relationships and communication between a user and a set of services in accordance with the techniques presented herein.

FIG. 6 is an illustration of an exemplary computer-readable medium comprising processor-executable instructions configured to embody one or more of the provisions set forth herein.

FIG. 7 is an illustration of an exemplary scenario featuring a configuration of a communication manager to track communication channels of a user and to regulate communication of respective services with the user through one or more communication channels.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

FIG. 1 presents an illustration of an exemplary scenario 100 featuring communication between a user 102 and a set of services 108, such as websites or web services provided for the user 102. Respective services 108 often allow the user 102 to create a user profile 110 involving a set of information about the user 102, such as the user's name, a selected or assigned username within the service 108, password, a credit card of the user 102, and a set of communication channels through which the user 102 may be contacted, such as the user's mailing address, an email address of a mail account 104, and the phone number of a mobile phone 106 through which the user 102 may be contacted by voice call or simple message service (SMS). The user 102 may be permitted to utilize such information while participating in the service 108, e.g., by logging in with a username and password, ordering products or service to be billed using the stored credit card information, Additionally, using the contact information provided in the user profile 110, respective services 108 may send various messages 112 to the user 102 regarding the provided services, such as orders for products or services placed by the user 102 and the availability of products or services in which the user 102 may be interested. Many such services 108 may also allow the user 102 to customize the communication provided by the service 108 to the user 102. For example, a service 108 may permit the user 102 to subscribe to, unsubscribe from, and/or adjust the content and/or frequency of advertisements about the products and services.

However, within scenarios such as the exemplary scenario 100 of FIG. 1, a wide variety of problems may arise. As a first example, the user 102 may have to create a user profile 110 with each service 108, which may involve re-entering the same information repeatedly to a potentially large number of services 108. As a second example, the information in different user profiles 110 may be inconsistent; e.g., the user 102 may choose a first username with a first service 108 that is already in use by another user 102 of a second service 108, and the user 102 may have to remember a variety of usernames or passwords. As a third example, maintaining the freshness of information in each user profile 110 may be difficult; e.g., if the user 102 changes mail accounts 104, the user 102 may have to remember to update the user profile 110 of each service 108 to indicate the new mail account 104. For example, if the second service 108 is not updated with the new mail account 104, messages 112 from the second service 108 may result in a failure 116 to reach the user 102, and the user 102 may not even be informed or aware of the failure 116. As a fourth example, if the user 102 re-uses information in the various user profiles 110 established with different services 108, a first service 108 may be able to access the user profile 110 of the same user 102 through a second service 108 without the authorization of the user 102. For example, if the user 102 uses the same username and password with a banking website and an untrusted service, the untrusted service may be able to access the user profile 110 of the user 102 for the banking service, and may be able to retrieve unauthorized information or initiate transactions that the user 102 has not authorized. As a fifth example, the user 102 may disclose his or her identity as part of the user account (e.g., because some services 108 refuse to interact with the user 102 in an anonymous or pseudonymous manner), but the user 102 may later be unable to disavow a personal association with the user profile 110.

Additionally, many problems may arise involving communication from the services 108 that is unwanted by the user 102. For example, the user 102 may regard messages 112 from the first service 108 and the second service 108 as wanted 114, and may find such communication satisfactory. However, message 112 from a third service 108 may be unwanted 118 in many respects. As a first example, the user 102 may initially regard messages 118 from the third service 108 as wanted 114, but may later have a change of opinion and may no longer want to receive messages 112. For example, the user 102 may lose interest in the third service 108, may feel that the messages 112 from the third service 108 are uninteresting or too frequent, or may stop using the third service 108). However, the third service 108 may continue to send messages 112 to the user 102 that are now unwanted 118. Moreover, the third service 108 may offer the user 102 no option to cease the transmission of the unwanted messages 112 (e.g., providing no option to unsubscribe from the transmission of messages 112), or may provide such options but not adhere to the selections of the user 102. As a second example, the user 102 may wish to receive messages 112 from the third service 108 through a first communication channel (e.g., through the user's mail account 104), but the service 108 may also send messages 112 to the user 102 through a second communication channel (e.g., through voice calls or simple message service (SMS) messages sent to the user's mobile phone 106). Having provided information about such communication channels, possibly without understanding or being informed that the service 108 intended to send messages 112 through such communication channels, the user 102 may be unable to request the third service 108 to revoke permission the ability of the third service 108 to use the disclosed communication channels to contact the user 102. As a third example, the third service 108 may, with or without the user's permission 102, share 120 the user profile 110 of the user 102 with a third party, such as an advertiser 122, which may send a potentially voluminous set of messages 112 that the user 102 regards as unwanted 118, including voice and simple message service (SMS) messages placed by a telemarketing advertiser 122, and bulk unsolicited email (“spam”) messages. In many such scenarios, the advertiser 122 may refuse to cease the delivery of unwanted messages 112 to the user 102, and it may even be difficult for the user 102 to identify the advertiser 122 sending such messages 112, or to determine which service 108 how the advertiser 122 provided the contact information of the user 102 to the advertiser 122.

Faced with such problems, users 102 may utilize a wide variety of resources to reduce or eliminate the receipt of messages 112 and other forms of communication that the user 102 regards as unwanted 118. As a first example, the user 102 may implement various message filtering techniques through the mail account 104, such as spam filters and blacklists, in order to exclude messages 112 and services 108 from which communication is unwanted 118, and/or may configure a mobile phone 106 to block incoming calls and/or SMS messages from a service 108 that sends unwanted messages 112. However, the maintenance of such filters may be cumbersome (e.g., maintaining a set of rules indicating the filters for the mail account 104 may be a time-consuming and unpleasant maintenance task), and may be partly or largely ineffective (e.g., “spam” advertisers 122 often send bulk unsolicited email messages 112 through a wide variety of senders and with a widely varying content, and the filtering techniques of the mail account 104 may be unable to exclude many such messages 112). Moreover, such filtering techniques may result in false positives, where messages 112 that the user 102 regards as wanted 114 are incorrectly categorized as unwanted 118 and withheld from the user 102 or deleted. As a second example, the user 102 may invoke various legal, procedural, or technical intermediary resources, such as subscribing to a “do not call” telemarking registry, or persuading a service provider (such as a carrier of mobile phone service) to block calls or other communication from services 108 that chronically send unwanted messages 112. In some cases, the user 102 may even abandon a communication channel through which the user 102 receives too many unwanted messages 112, such as abandoning a mail account 104 and utilizing a second mail account 104. However, such transitions may be cumbersome tasks and may disrupt legitimate communication with the user 102 (such as the failure 116 of the second service 108 to deliver messages 112 that the user 102 regards as wanted 114). These and other problems and disadvantages may arise in the communication models such as illustrated in the exemplary scenario 100 of FIG. 1.

### B. Presented Techniques

FIG. 2 presents an illustration of an exemplary scenario 200 featuring a different model for facilitating communication between a user 102 and a set of services 108. In accordance with this model, a user 102 may utilize a communication manager 202 that regulates communication between the services 108 and the communication channels of the user 102. The communication manager 202 may provide a wider variety of options to the user 102 for respective service 108 than may be offered by the services 108, and may apply the preferences of the user 102 to the regulation of communication with high reliability and accuracy, and with greater convenience and security than other communication models.

In particular, the communication manager 202 may be configured to establish a set of relationships 204 between the user 102 and respective services 108 that the user 102 may wish to utilize. For example, when the user 102 initially visits a service 108, the user 102 and/or the service 108 may initiate a request 206 with the communication manager 202 to establish a relationship 204 with the user 102. In response, the communication manager 202 may store an internal representation of the relationship 204, an may issue to the communication service 108 a token 208 representing the relationship 204, e.g., indicating the permission granted by the user 102 to send messages 112 or other communication to the user 102. Notably, the communication manager 202 may establish the relationship 204 and issue the token 208 in a partially or wholly automated manner, e.g., without prompting the user 102 to enter the details of a user profile 110 for the service 108. Additionally, the token 208 and relationship 204 may be used to regulate the delivery of messages 112 and other forms of communication that the service 108 requests to send to the user 102. In particular, when a service 108 wishes to contact the user 102, the service 108 may send the message 112 or a request to initiate communication with the user 102 to the communication manager 202, along with the token 208 identifying the relationship 204 with the user 102. The communication manager 202 may compare the token 208 with the relationship 204 to the service 108 defined by the user 102, and may permit or deny the communication based on this comparison. As a first example, the service 108 may accept and review the message 112 proposed by the service 108 along with the token 208, and may forward or discard the message 112 based on whether or not the relationship 204 between the user 102 and the service 108 currently authorizes communication from the service 108. As a second example, the service 108 may be able to contact the user 102 directly (e.g., sending messages directly to the mail account 104 or initiating calls to a mobile phone 106), but these communication channels may verify with the communication manager 202 the permission of the service 108 to contact the user 102 before presenting the communication to the user 102.

The techniques illustrated in the exemplary scenario 200 of FIG. 2 may be capable of exhibiting a wide range of advantages with respect to other techniques (including the exemplary scenario 100 of FIG. 1). As a first example, the communication manager 202 may alleviate the user 102 of the task of creating user profiles 110 with each service 108 including redundant or conflicting information. As a second example, the communication manager 202 may alleviate the task of updating user profiles 110 if the information of the user 102 changes; e.g., if the user 102 switches to a different mobile phone 106 having a different phone number, the user 102 may simply notify the communication manager 202, which may thenceforth direct calls to the new mobile phone 106 and/or automatically update the services 108 with the new phone number. Thus, if the second user 18 sends a message 112 that the user regards as wanted 114, but the user 102 has not explicitly informed the second service 108 of a change of mail accounts 104, the communication manager 202 may enable the delivery of the wanted message 112 to the user 102 through the new mail account 104. As a third example, the communication manager 202 may anonymize or pseudonymize the relationship 204 between the user 102 and the service 108; e.g., the communication manager 202 may obscure personally identifying information, such as the personal phone number or email address of the user 102, and may interact with the service 108 in a manner that does not personally identify the user 102. As a fourth example, the communication manager 202 may handle other details of the interaction with the user 102, such as authenticating the identity of the user 102 and verifying the associations of the communication channels with the user 102 (e.g., verifying that a particular mobile phone 106 belongs to the user 102), and may synchronize such details across several devices and communication channels operated by the user 102 (e.g., blocking an advertiser 122 from sending unwanted messages 112 to the user 102 through any of the devices or communication channels of the user 102).

Many further advantages relate to the regulation of communication between the services 108 and the user 102. As a first example, by communicating with the services 108 through the use of a token 208, the communication manager 202 may provide a standardized communication mechanism, and may verify that the token 208 was generated by the communication manager 202 and has not been altered by the service 108 (e.g., through cryptographic signature techniques). As a second example, communication with services 108 through the communication manager 202 may enable a centralization of communication across services 108 and communication channels (e.g., a centralized manager of email, voice, SMS, and physical mail communication). Such centralization may enable centralized management of communication permissions; centralized access to such messages; and/or a single source of push notifications regarding the receipt of new messages from a variety of services 108 and through a variety of communication channels. As a third example, the communication manager 202 may permit the user 102 to extend, alter, or revoke the permission of a service 108 to communicate with the user 102, and the communication manager 202 may promptly and reliably apply the permission of the user 102 (rather than delegating such regulation to the service 108, which may provide few or no such options, and which may have an interest in not respecting requests by the user 102 to restrict or cease communication). As a fourth example, the user 102 may specify that a particular service 108 is only permitted to send particular types of messages 112, and/or to communicate with the user 102 only through particular communication channels. The communication manager may apply a wider variety of such options than the services 108 may provide, and may automatically and accurately apply such options on behalf of the user 102. As a fifth example, the communication manager 202 may establish distinctive or unique relationships 204 with respective services 108, such that the token 208 provided by a first service 108 is unusable by a second service 108, and/or is unusable by the first service 108 to access a user profile 110 of the second service 108. For example, if the third service 108 shares the token 208 of the user 102 with an advertiser 122, the communication manager 202 may determine that the token 208 was not issued to the advertiser 122 sending the message 112, and may block 310 delivery of the message 112 of the advertiser 122 to the user 102. These and other advantages may be achievable through the regulation of communication between the services 108 and the user 102 through a communication manager in accordance with the techniques and architectures presented herein.

### C. Exemplary Embodiments

FIG. 3 presents a first exemplary embodiment of the techniques presented herein, illustrated as an exemplary method 300 of configuring a communication manager 202 to facilitate relationships between services 108 and users 102. The exemplary method 300 may be implemented, e.g., as a set of instructions stored in a memory component of the device, such as a memory circuit, a platter of a hard disk drive, a solid-state storage device, or a magnetic or optical disc, and organized such that, when executed by the device (e.g., on a processor of the device), cause the device to operate according to the techniques presented herein. The exemplary method 300 begins at 302 and involves executing 304 the instructions on a processor of the device. Specifically, these instructions may be configured to, upon receiving 206 a request 206 to establish a relationship 204 between a user 102 and a service 108, generate 308 a token 208 identifying the relationship 204 with the user 102, and send 310 the token 208 to the service 108. The instructions may be further configured to, upon receiving 312 from a service 108 a token 308 and a request from the service 108 to communicate with the user 102, verify 314 that the relationship 204 represented by the token 308 permits communication between the service 108 and the user 102; and after verifying the token 208 and the relationship 204, permit 316 the service 108 to communicate with the user 102. Having achieved the configuration of the device to serve as a communication manager 202 facilitating communication between the services 108 and the user 102 in this manner, the exemplary method 300 achieves the techniques presented herein, and so ends at 318.

FIG. 4 presents a second exemplary embodiment of the techniques presented herein, illustrated as an exemplary method 400 of configuring a device of a user 102 to manage communication between services 108 and the user 102 with the participation of a communication manager 202. The exemplary method 400 may be implemented, e.g., as a set of instructions stored in a memory component of the device, such as a memory circuit, a platter of a hard disk drive, a solid-state storage device, or a magnetic or optical disc, and organized such that, when executed by the device (e.g., on a processor of the device), cause the device to operate according to the techniques presented herein. The exemplary method 400 begins at 402 and involves executing 404 the instructions on a processor of the device. Specifically, these instructions may be configured to, upon receiving a request to establish a relationship between the user and a service, request 404 the communication manager 202 to establish a relationship 204 with the service 108 on behalf of the user 102. The instructions are also configured to, upon receiving 408 a communication from the service 108, verify 410 with the communication manager 202 that the relationship 204 between the service 108 and the user 102 permits the communication; and after verifying the relationship 204 with the communication manager 202, present 412 the communication from the service 108 to the user 102. Having achieved the configuration of the device to interact with a communication manager 202 in order to manage communication between the services 108 and the user 102 in this manner, the exemplary method 400 achieves the techniques presented herein, and so ends at 414.

FIG. 5 presents third and fourth exemplary embodiments of the techniques presented herein, illustrated, respectively as an exemplary system 508 for configuring a client device 502 to manage communication between a service 108 and a user 102 through interaction with a communication manager 514, and an exemplary system 518 for facilitating communication between services 108 and users 102 through one or more client devices 502. Respective components of the respective exemplary systems may be implemented, e.g., as a set of instructions stored in a memory 506 of the respective devices and executable on a processor 504 of the devices, such that the interoperation of the components causes the respective devices to operate according to the techniques presented herein. In this exemplary scenario 500, the exemplary system 508 implemented on the client device 502 comprises a relationship establishing component 510 that is configured to, upon receiving a request 206 to establish a relationship 204 between the user 102 of the client device 502 and a service 108, request the communication manager 514 to establish a relationship 204 with the service 108 on behalf of the user 102. The exemplary system 508 also comprises a communication verifying component 512, which is configured to, upon receiving a communication from the service 108, verify with the communication manager 514 that the relationship 204 between the service 108 and the user 102 permits the communication, and after verifying the relationship 204 with the communication manager 514, present the communication from the service 108 to the user 102. As further illustrated in this exemplary scenario 500, the exemplary system 518 implemented on the communication manager 514 comprises a relationship establishing component 520 that is configured to, upon receiving a request 206 to establish a relationship 204 between a user 102 and a service 108, generate a token 208 identifying the relationship 204 between the service 108 and the user 102, and send the token 208 to the service 108. The exemplary system 518 also comprises a communication authorizing component 522, which is configured to, upon receiving from a service 108 a token 208 and a request to communicate with the user 102, verify that the relationship 204 represented by the token 208 permits communication between the service 108 and the user 102, after verifying the relationship 204, permit the service 108 to communicate with the user 102. In this manner, the exemplary system 508 operating on the client device 502 and the exemplary system 518 operating on the communication manager 514, in the manner illustrated in the exemplary scenario 500 of FIG. 5 may interoperate to manage communication between one or more users 102 and one or more services 108 in accordance with the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

An exemplary computer-readable medium that may be devised in these ways is illustrated in FIG. 6, wherein the implementation 600 comprises a computer-readable medium 602 (e.g., a CD-R, DVD-R, or a platter of a hard disk drive), on which is encoded computer-readable data 604. This computer-readable data 604 in turn comprises a set of computer instructions 606 configured to operate according to the principles set forth herein. In a first such embodiment, the processor-executable instructions 606 may be configured to perform a method 608 of facilitating communication between users 102 and services 108, such as the exemplary method 300 of FIG. 3. In a second such embodiment, the processor-executable instructions 606 may be configured to perform a method 608 of configuring a client device 502 of a user 102 to manage communication between the user 102 of a client device 502 and one or more services 108 by interacting with a communication manager 514, such as the exemplary method 400 of FIG. 4. In additional embodiments, the processor-executable instructions 606 may be configured to implement systems for facilitating or managing communication between a user 102 and one or more services 108, such as the exemplary system 508 operating on the client device 502 and/or the exemplary system 518 operating on the communication manager 514 in the exemplary scenario 500 of FIG. 5. Some embodiments of this computer-readable medium may comprise a computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3; the exemplary method 400 of FIG. 4; and the exemplary systems 508, 518 of FIG. 5) to confer individual and/or synergistic advantages upon such embodiments.

D1. Scenarios

A first aspect that may vary among embodiments of these techniques relates to the scenarios wherein such techniques may be utilized.

As a first variation of this first aspect, the techniques presented herein may be utilized with many types of client devices 502, such as servers, server farms, workstations, laptops, tablets, mobile phones, game consoles, and network appliances. Such client devices 502 may also provide a variety of computing components, such as wired or wireless communications devices; human input devices, such as keyboards, mice, touchpads, touch-sensitive displays, microphones, and gesture-based input components; automated input devices, such as still or motion cameras, global positioning service (GPS) devices, and other sensors; output devices such as displays and speakers; and communication devices, such as wired and/or wireless network components.

As a second variation of this first aspect, the communication manager 514 implementing the techniques presented herein may be positioned in many locations within the exemplary scenarios featuring these techniques, and may service various sets of users 102. As a first such example, the communication manager 514 may comprise a cloud service that is available over a wide-area network, such as the Internet, to regulate communication between users 102 and various services provided over the Internet, such as websites and web services. As a second such example, the communication manager 514 may be positioned at a gateway to an institution or network, such as a school, an organization, or a local area network of one or more users 102, and may regulate communication between the users 102 of the institution or network and services 108 provided thereby. As a third such example, the communication manager 514 may be positioned in front of a set of services 108, and may enable any user 102 to establish a relationship 204 and communicate with the services 108 through the communication manager 514. As a fourth such example, the communication manager 514 may be implemented on a client device 502, such as a mobile phone, and may regulate communication of various services 108 with the user 102 through the client device 502 and, optionally, other client devices 502 operated by the same or different users 102.

As a third variation of this first aspect, the techniques provided herein may regulate or facilitate many types of communication between users 102 and services 108 through many types of communication channels. Some exemplary communication types and communication channels may include, e.g., a mailing address communication channel; a telephone communication channel; an audio- or videoconferencing communication channel; a telepresence communication channel; an email communication channel; a chat message communication channel (e.g., instant messages exchanged in a chat service or social network); a simple message service communication channel; and a network interface communication channel (such as the ability of a service 108 to contact a client device 502 of the user 102 over a network).

As a fourth variation of this first aspect, the techniques provided herein may establish many types of services 108 and relationships 204 between users 102 and services 108. As a first such example, the services 108 may include informational services; commercial services; social services, such as social networks; and data services, such as file transfer. As a second such example, the relationships 204 may include commercial, academic, and/or professional relationships; membership of the user 102 in a group or organization; and a service-oriented relationship where the user 102 simply invokes the services of the service 108.

As a fifth variation of this first aspect, the communication manager 514 and/or client device 502 may present various architectures for interacting with the user 102 and/or the services 108. As a first example, the communication manager 514 and/or client devices 502 may present a human-interactive user interface, such as a web page with user controls that the user 102 and/or an administrator of the service 108 may operate to establish relationships 204, issue tokens 208, and receive permission for communication therebetween. As a second example, the communication manager 514 and/or client devices 502 may provide an interface that another software or hardware process may invoke to establish relationships 204, issue tokens 208, and receive permission for communication. For example, the communication manager 514 may comprise a web service that respective users 102, client devices 502, and/or services 108 may invoke with various types of requests 206; and/or the client devices 502 may comprise a local webserver that may be accessible to and interact with the communication manager 514 and/or service 108. As a third example, the communication manager 514 and/or client devices 502 may comprise a portable programming library or proxy, such as an application programming interface (API), that a client device 502, communication manager 514, and/or service 108 may locally invoke with various requests 206, and which may fulfill such requests by interacting with the communication manager 514 and/or client device 502. These and other variations may be suitable for implementations of the techniques presented herein.

D2. Relationship Establishment and Token Issuance

A second aspect that may vary among embodiments of these techniques relates to the manner of establishing relationships 204 between users 102 and services 108, and issuing tokens 208 representing such relationships 204, in accordance with the techniques presented herein.

As a first variation of this second aspect, the user 102 may first create a user profile 110 with the communication manager 514, e.g., indicating the available set of communication channels of the user 102. The communication manager 514 may therefore store in the user profile 110 the relationships 204 created between the user 102 and the services 108, and/or may associate tokens 208 generated for various services 108 with the relationships 204 represented in the user profile 110. The storage of a user profile 110 may be advantageous, e.g., for allowing the user 102 to alter the stored relationships 204; for reissuing tokens 208 to services 108 that represent changes to the relationship 204 with the service 108; and for comparing a token 208 received with a request 206 to the stored relationship 204 represented by the token 208, e.g. in order to verify that the token 208 has not been altered by the service 108. The storing by the communication manager 514 of a user profile 110 for the user 102 may enable other features. For example, the user profile 110 of the user 102 may include at least one authentication credential that may be usable to verify that requests to establish relationships 204 and issue tokens 208 are received from the user 102. Accordingly, the communication manager 514 may be configured to establish relationships 204 and/or issue tokens 208 only after authenticating the user 102 according to the at least one authentication credential. Alternatively or additionally, the communication manager 514 may be configured to synchronize the user profile 110 of the user 102 with one or more other devices of the user 102, e.g., in order to configure all of the user's devices to utilize the same set of current authorization credentials to authenticate the user 102.

As an alternative first variation of this second aspect, the communication manager 514 may forgo storing user profiles 110 for users 102, and may simply issue tokens 208 to respective services 108 representing and expressing the relationship that the user 102 wishes to have with the service 108. The service may later determine whether or not to permit a communication between a service 108 and a user 102 based solely on the permissions and relationship encoded in the token 208, and a cryptographic signature of the token 208 may enable the communication manager 514 to verify that the service 108 has not altered the token 208.

As a second variation of this second aspect, the communication manager 514 may be configured to fulfill many types of requests 206 to establish relationships 204 between a user 102 and one or more services 108. As a first example, the request 206 may be initiated by the user 102, e.g., through an explicit indication from the user 102 of an intent to establish a relationship 204, or as an implicit indication from the user 102, such as a request from the user 102 to visit a website or initiate a transaction with a commercial service, or otherwise interact with a service 108 with which the user 102 does not currently have a relationship 204. As a second example, the request 206 may be initiated by the service 108, e.g., by embedding in the source code of a web page provided by the website. The request 206 may be received from the client device 502 of the user 102, which may forward the request 206 to the communication manager 514 for the user 102. As a further variation of this second example, the client device 502 and/or communication manager 514 may first ask the user 102 to verify or accept the request to establish a relationship 204 between the service 108 and the user 102, and may condition the establishment of the relationship 204 upon receiving verification or acceptance from the user 102. Alternatively, the client device 502 and/or communication manager 514 may automatically establish the relationship 204 without notifying the user 102 (e.g., refraining from soliciting input from the user 102 in establishing the relationship 204 with the service 108 on behalf of the user 102), or while sending only a passive notification to the user 102. Such automated, unverified establishment may be advantageous, e.g., for maintaining an available stock of relationships 204 with services 108 that the user 102 may later wish to use, and for reducing or eliminating the involvement of the user 102 in the establishment of the relationship 204. Notably, in some scenarios, the establishment of the relationship 204 may be decoupled from the issuance of a token 208 permitting the service 108 to contact the user 102. Rather, the relationship 204 with the service 108 may be established simply to establish an identifier for the user 102 with the service 108, so that tokens 208 are ready for prompt issuance if the user 102 later indicates permission for the services 108 to contact the user 102. Alternatively, before receiving any indication of such permission from the user 102, the communication manager 514 may issue a token 208 to the service 108 indicating no such permission, but representing the relationship 204 established between the user 102 and the service 108, even if the relationship 204 has not yet been granted any contact privileges by the user 102.

As a third variation of this second aspect, upon receiving a request 206 to establish a relationship 204 with a service 108, the communication manager 514 and/or client device 502 may identify a trust rating of the service 108, and may present to the user 102 a recommendation concerning the establishment of the relationship 204 based on the trust rating of the service 108. For example, services 108 associated with an acceptable trust rating may result in a positive recommendation for the user 102 to establish a relationship 204 with the service 108, while services 108 associated with a low trust rating (e.g., services 108 alleged to have defrauded users, distributed malware, or masquerading as legitimate other services 108) may result in a negative recommendation for the user 102 warning against establishing a relationship 204 with the service 108.

As a fourth variation of this second aspect, an embodiment of these techniques (such as the communication manager 514 and/or the client device 502) may, while establishing a relationship 204 with the service 108, disclose and optionally authenticate the identity of the user 102 to the service 108. For example, if the service 108 already has a preexisting relationship with the user 102 (e.g., a banking service with which the user 102 already has a bank account), the communication manager 514 and/or client device 502 may identify the user 102 to the service 108 in order to match the newly established relationship 204 with the preexisting relationship, and may even authenticate the user 102 for the service 108 (e.g., disclosing to the service 108 a username, password, personal information, and/or biometrics for verification by the service 108). Alternatively, the communication manager 514 and/or client device 502 may obscure the user identity of the user 102 in the relationship 204 established with the service 108 and represented by the token 208, e.g., by redacting personally identifying information in communications with the service 108 and/or substituting such information with false or misleading information. Such embodiments may therefore enable the establishment of an anonymous or pseudonymous identity with the service 108. In some such embodiments, the communication manager 514 may endeavor to establish the same pseudonym among two or more services 108, e.g., providing and maintaining a consistent pseudonymous identity of the user 102 among different services 108. These variations may enable the service 108 to verify that subsequent communications are with the same user 102 (e.g., that the service 108 is consistently communicating only with the user 102 for whom the relationship 204 is established), even if the identity of the user 102 is withheld. These and other variations in the establishment of the relationship 204 between the user 102 and the service 108 may be included in embodiments of the techniques presented herein.

D3. Communication Management

A third aspect that may vary among embodiments of these techniques relates to the facilitation and management of communication between the user 102 and one or more services 108.

As a first variation of this third aspect, the communication manager 514 may mediate the user 102 and the service 108, such that communication from the service 108 to the user 102 is delivered only through the communication manager 514. Accordingly, the request 206 to communicate with the user 102 presented by the service 108 to the communication manager 514 may comprise the proposed message 112 and the token 208, and the communication manager 514 may examine the token 208 and the relationship 204 represented thereby (and, in some embodiments, associated therewith) to determine whether or not to send the message 112 to the user 102. Such embodiments may also include forms of communication other than messages 112; e.g., the communication manager 514 may establish a voice communication session (such as a phone call) between the service 108 and the user 102, which may obscure the personal phone number of the user 102 in order to preclude the service 108 from directly contacting the user 102.

As a second variation of this third aspect, the communication manager 514 may regulate direct contact between the service 108 and the user 102 by advising the user 102 of whether or not to accept a proposed communication from the service 108. As a first example, when a service 108 requests to initiate direct contact with the user 102, the communication manager 514 may determine whether such contact is authorized, and may directly advise the user 102 of whether or not to accept the communication (e.g., “this caller is among your blocked services list”), and the client device 502 may present the advice of the communication manager 514 to the user 102. As a second example, the communication manager 412 may present such advice to the client device 502, which may choose either to accept the requested communication (e.g., presenting a message 112 from the service 108 to the user 102) or reject the requested communication (e.g., discarding the message 112 or blocking an incoming call).

As a third variation of this third aspect, the communication manager 514 may permit or prohibit communication between the service 108 and the user 102 based on additional criteria specified by the user 102. As a first such example, the evaluation of a request to communicate with the user 102 may include an inspection of the content of the communication; e.g., the user 102 may have indicated that the relationship 204 with the service 108 includes only a particular set of included topics and/or excludes a particular set of excluded topics, and the communication manager 514 may forward or reject portions or the entirety of the message 112 based on an inspection of the topical content. As a second such example, the user 102 may have one or more communication channels through which the user 102 receives communication (e.g., a mail account 104 through which the user 102 may receive email messages; a mobile phone 106 through which the user 102 may receive phone calls and/or simple message service (SMS) messages; and a home mailing address where the user 102 may receive physical mail and packages). The user 102 may specify criteria regarding such communication channels that may be included in the evaluation of a request 206 (e.g., the user 102 may indicate that services 108 may only contact the user 102 by voice contact during business hours), and the communication manager 514 may only permit services 108 to send communication through at least one communication channel associated with the user and authorized for the service 108. Alternatively or additionally, the user 102 may specify particular per-server, per-communication-channel permissions, e.g., authorizing respective services 108 to use one or more of the communication channels, and may prohibit the same service 108 from using one or more other communication channels. For example, the user 102 may permit a service 108 to contact the user 102 by email or simple message service (SMS), but not by voice call or mailing address. The communication manager 202 may receive such selections from the user 102, and may store such authorizations in the stored relationship 204 and/or user profile 110 of the user 102, and/or may encode such authorizations in the token 208 sent to the service 108. Upon receiving a request 206 from the service 108 to communicate with the user 102 through a particular communication channel, the communication manager 202 may fulfill the request 206 by determining whether the service 108 is authorized to communicate with the user 102 through the requested communication channel. Alternatively or additionally, the communication manager 514 may disclose the details of a communication channel to the service 108 in order to permit the service 108 to contact the user 102 directly.

As a fourth variation of this third aspect, one or more communication channels operated by a user 102 may comprise a dynamic communication channel that is accessible at a first time through a first address, and at a second time through a current address (and no longer accessible through the first address). As a first example, the user 102 may operate two or more mobile phones 106 having different phone numbers, and may at various times be reachable through one or both of the mobile phones 106. As a second example, the user 102 may operate a mobile device that is accessible over a network such as the Internet, but the address of the mobile device may change during transitions between mobile networks. An embodiment of these techniques may be further configured to track the current address of the dynamic communication channel of the user 102, such that permitted requests 206 from services 108 to communicate with the user 102 may be routed to the current address of the dynamic communication channel.

FIG. 7 presents an illustration of an exemplary scenario 700 featuring several variations of the techniques presented herein. In this exemplary scenario 700, the user 102 of an email account 104 and a mobile phone 106 establishes a user profile 110 with the communication manager that indicates the communication channels 704 through which the user 102 is reachable. Additionally, the user 102 may indicate to the communication manager 302 that particular relationships 204 with particular services 108 are authorized to use particular communication channels 704; e.g., the first service 108 may be permitted by the relationship 204 to contact the user 102 only through the mail account 104 or by chat message contact with the mobile phone 106, but may be restricted from initiating voice calls through the mobile phone 106 of the user 102. Moreover, the mobile phone 106 may have a dynamic address 702 that changes as the user 102 transitions between mobile communication networks, and the communication manager 302 may track the address 702 of the dynamic communication channel 704 associated with the mobile phone 106. Accordingly, when a service 108 requests to contact the user 102, the communication manager 302 may compare the details of the request 20 with the token 208 provided by the service 108 and the details of the relationship 204 represented by the token 208, in order to verify that the user 102 has authorized the service 108 to contact the user 102 through the specified communication channel 704. Additionally, if such communication is authorized, the communication manager 302 may facilitate the communication by connecting the service 108 with the user 102 through the current address 702 of a dynamic communication channel 704. These and other advantages may be achievable to facilitate and manage communication between services 108 and users 102 through the implementation of the communication manager 302 and/or client device(s) 502 in accordance with the techniques presented herein.

### E. Computing Environment

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection, or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

### F. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of facilitating relationships between services and users, the method involving a device having a processor and comprising:
executing on the processor instructions configured to:
upon receiving a request to establish a relationship between a user and a service:
generate a token identifying the relationship with the user, and
send the token to the service; and
upon receiving from a service a token and a request from the service to communicate with the user:
verify that the relationship represented by the token permits communication between the service and the user; and
after verifying the token and the relationship, permit the service to communicate with the user.

2. The method of claim 1:
the device storing a user profile of the user; and
generating the token identifying the relationship with the user further comprising: associating the token with the user profile of the user.

3. The method of claim 2:
the user profile of the user including at least one authentication credential; and
generating the token comprising:
authenticating the user according to the at least one authentication credential; and
upon authenticating the user, generating the token identifying the relationship with the user.

4. The method of claim 2:
the user associated with at least one other device; and
the instructions further configured to synchronize the user profile of the user with the at least one other device of the user.

5. The method of claim 1:
the request received from the service; and
the instructions further configured to, upon receiving the request from the service, requesting from the user a verification of the request from the service to establish a relationship with the user; and
sending the token to the service comprising: upon receiving from the user a verification of the request from the service to establish a relationship with the user, send the token to the service.

6. The method of claim 5, requesting the verification from the user further comprising:
identifying a trust rating of the service; and
presenting to the user a recommendation based on the trust rating of the service.

7. The method of claim 1:
the user having a user identity; and
sending the token to the service comprising: obscuring the user identity of the user in the relationship represented by the token.

8. The method of claim 1:
the user having a user identity; and
sending the token to the service comprising: identifying the user identity of the user in the relationship represented by the token.

9. The method of claim 1:
the request to communicate comprising a message to be delivered to the user; and
permitting the service to communicate with the user comprising: sending the message to the user.

10. The method of claim 1, permitting the service to communicate with the user comprising: advising the user to accept communication with the server.

11. The method of claim 1:
respective users having a user profile identifying at least one communication channel through which the user receives communication; and
permitting the service to communicate with the user comprising: permitting the service to send communication through at least one communication channel associated with the user.

12. The method of claim 11, respective communication channels of the user selected from a communication channel set comprising:
a mailing address communication channel;
a telephone communication channel;
an email communication channel;
a chat message communication channel;
a simple message service communication channel; and
a network interface communication channel.

13. The method of claim 11:
the user profile identifying, among the communication channels through which the user receives communication, at least one communication channel authorized for the service; and
permitting the service to communicate with the user comprising: permitting the service to send communication through at least one communication channel associated with the user and authorized for the service.

14. The method of claim 13, the instructions further configured to, upon receiving from the user a request specifying an authorization of the communication channel for the service, store the authorization for the service in the user profile of the user.

15. The method of claim 11:
at least one communication channel comprising a dynamic communication channel that is accessible at a first time through a first address, and at a second time through a current address and not the first address; and
the instructions further configured to track the current address of the dynamic communication channel of the user.

16. A method of managing communication between services and a user of a device having a processor and having access to a communication manager, the method comprising:
executing on the processor instructions configured to:
upon receiving a request to establish a relationship between the user and a service, request the communication manager to establish a relationship with the service on behalf of the user; and
upon receiving a communication from the service:
verify with the communication manager that the relationship between the service and the user permits the communication; and
after verifying the relationship with the communication manager, present the communication from the service to the user.

17. The method of claim 16, the request to establish the relationship between the user and the service received from the service in response to an interaction with the service initiated by the user.

18. The method of claim 17, requesting the communication manager to establish the relationship with the service on behalf of the user further comprising: refraining from soliciting input from the user in establishing the relationship with the service on behalf of the user.

19. The method of claim 16:
the device storing at least one authentication credential of the user; and
requesting the communication manager to establish the relationship with the service on behalf of the user further comprising:
authenticating the user according to the at least one authentication credential; and
upon authenticating the user, requesting the communication manager to establish the relationship with the service on behalf of the user.

20. A system for facilitating, on a device having a processor and a memory, relationships between services and users, the system comprising:
a relationship establishing component comprising instructions stored in the memory that, when executed on the processor, cause the device to:
upon receiving a request to establish a relationship between a user and a service:
generate a token identifying the relationship between the service and the user, and
send the token to the service; and
a communication authorizing component comprising instructions stored in the memory that, when executed on the processor, cause the device to:
upon receiving from a service a token and a request to communicate with the user:
verify that the relationship represented by the token permits communication between the service and the user; and
after verifying the token and the relationship, permit the service to communicate with the user.
